(19) United States
(12) Patent Application Publication
(10) Pub. No.: US 2011/0285456 A1
(43) Pub. Date: Nov. 24, 2011

(54) FOUR-TERMINAL SOI MESFET BASED LOW DROPOUT REGULATOR

(75) Inventors: Trevor John Thornton, Fountain Hills, AZ (US); Seth Wilk, Chapel Hill, NC (US); Asha Balijepalli, Sunnyvale, CA (US); William Lepkowski, Tempe, AZ (US)

(73) Assignee: Arizona Board of Regents for and on behalf of Arizona State University, Scottsdale, AZ (US)

(21) Appl. No.: 13/147,245

(22) PCT Filed: Feb. 5, 2010
(86) PCT No.: PCT/US2010/023263

§ 371 Date: Aug. 1, 2011

Related U.S. Application Data
(60) Provisional application No. 61/150,647, filed on Feb. 6, 2009.

(51) Int. Cl. G05F 1/10

(52) U.S. Cl. 327/541

(57) ABSTRACT

Embodiments of a Low Dropout (LDO) regulator are provided in which an n-channel Metal Semiconductor Field Effect Transistor (MESFET) is utilized as a pass transistor of the LDO regulator. In one embodiment, the LDO regulator is implemented on an integrated circuit die and includes an n-channel Semiconductor-on-lnsulator (SOI) MESFET pass transistor. A voltage applied to a substrate of the SOI MESFET pass transistor is controlled to configure the LDO regulator in either an ultra-low dropout voltage mode or a high Power Supply Rejection (PSR) mode. In another embodiment, the LDO regulator includes an re-channel MESFET pass transistor and a switch that operates to disconnect the MESFET pass transistor from a supply voltage of the LDO regulator when the LDO regulator is desired to be shut off.

### PRIORITY CLAIM

This application claims the benefit of U.S. Provisional Patent Application serial number 61/150,647, filed Feb. 6, 2009, the disclosure of which is hereby incorporated herein by reference in its entirety.

### FIELD OF THE DISCLOSURE

The present disclosure relates to a Low Dropout (LDO) regulator and, more specifically, to a LDO regulator having an n-channel Metal Semiconductor Field Effect Transistor (MESFET) pass transistor.

### BACKGROUND

Low Dropout (LDO) regulators are widely used to ensure that a voltage supplied to a circuit does not drift with time. For instance, LDO regulators are typically used for battery operated systems to ensure a constant output voltage even as the battery voltage drops with time. A key specification for LDO regulators is dropout voltage. The dropout voltage of an LDO regulator is a voltage difference between a regulated output voltage output by the LDO regulator and the nominal supply voltage. Typically, the dropout voltage corresponds to a voltage drop across a pass transistor of the LDO regulator at a defined operating point (e.g., when the regulated output voltage has fallen 2% below the nominal output voltage). The smaller the dropout voltage, the lower the battery voltage can fall before the LDO regulator ceases to function correctly, which translates directly to longer battery life. As such, there is a need for an LDO regulator having an ultra-low dropout voltage.

Another important specification for LDO regulators is Power Supply Rejection (PSR). For instance, noise in the supply voltage needs to be suppressed so as to not interfere with the circuit connected to the output of the LDO regulator. The PSR of the LDO regulator defines the noise reduction of the LDO regulator and is measured in decibels (dB). The larger the PSR in dB, the better the noise reduction. As such, there is also a need for an LDO having a high PSR.

### SUMMARY

Embodiments of a Low Dropout (LDO) regulator are provided in which an n-channel Metal Semiconductor Field Effect Transistor (MESFET) is utilized as a pass transistor of the LDO regulator. In one embodiment, the LDO regulator is implemented on an integrated circuit die and includes an n-channel Silicon-on-Insulator (SOI) MESFET pass transistor. A voltage applied to a substrate of the SOI MESFET pass transistor is controlled to configure the LDO regulator in either an ultra-low dropout voltage mode or a high Power Supply Rejection (PSR) mode. More specifically, for the ultra-low dropout voltage mode, the voltage applied to the substrate is a voltage that is greater than or equal to a nominal regulated output voltage of the LDO regulator. Preferably, a voltage greater than or equal to the nominal regulated output voltage is a supply voltage of the LDO regulator. For the high PSR mode, the voltage applied to the substrate is a voltage that is less than the nominal regulated output voltage of the LDO regulator. Preferably, a voltage less than the nominal regulated output voltage is Ground.

In one embodiment, the voltage applied to the substrate is re- configurable. For example, the LDO regulator may be implemented on an integrated circuit die that has a substrate voltage input pin. The substrate voltage input pin is used to configure the LDO regulator in either the ultra-low dropout voltage mode or the high PSR mode by applying the appropriate voltage to the substrate voltage input pin. In another embodiment, the LDO regulator voltage is configured in either the ultra-low dropout voltage mode or the high PSR mode by hard-wiring the substrate of the SOI MESFET pass transistor to an appropriate voltage during manufacturing.

In yet another embodiment, the LDO regulator includes a MESFET pass transistor and a switch connected in series between the MESFET pass transistor and a supply voltage of the LDO regulator. The switch is controlled to disconnect the MESFET pass transistor from the supply voltage of the LDO regulator under one or more predefined conditions in order to cut-off current flowing through the MESFET pass transistor. The one or more predefined conditions may include a short-circuit condition, a no-load condition, a low-battery condition, a power-down condition, or any combination thereof. In one embodiment, the switch is controlled by a control circuit by monitoring a regulated output voltage of the LDO regulator, a gate voltage of the MESFET pass transistor, or both the regulated output voltage of the LDO regulator and the gate voltage of the MESFET pass transistor. Preferably, the switch is a p-channel Metal Oxide Semiconductor (PMOS) transistor switch. Further, the PMOS transistor switch is preferably sized such that the PMOS transistor switch does not affect, or at least does not substantially affect, a dropout voltage of the LDO regulator.

Those skilled in the art will appreciate the scope of the present invention and realize additional aspects thereof after reading the following detailed description of the invention in association with the accompanying drawing figures.

### BRIEF DESCRIPTION OF THE DRAWING FIGURES

The accompanying drawing figures incorporated in and forming a part of this specification illustrate several aspects of the invention, and together with the description serve to explain the principles of the invention.

FIG. 1 illustrates a Low Dropout (LDO) regulator including a Silicon-on-Insulator (SOI) Metal Semiconductor Field Effect Transistor (MESFET) pass transistor wherein the LDO regulator is configurable in either an ultra-low dropout voltage mode or a high Power Supply Rejection (PSR) mode by application of an appropriate voltage to a substrate of the SOI MESFET pass transistor according to one embodiment of the present disclosure;

FIGS. 2A and 2B illustrate two exemplary embodiments of the SOI MESFET pass transistor of FIG. 1;

FIG. 3 graphically illustrates a relationship between a threshold voltage of the SOI MESFET pass transistor and a source-to-substrate voltage of the SOI MESFET pass transistor;

FIG. 4 graphically illustrates a relationship between a load current of the SOI MESFET pass transistor and a drain voltage, or supply voltage, applied to the SOI MESFET pass transistor;

FIG. 5 graphically illustrates a dropout voltage of the LDO regulator of FIG. 1 for two different substrate voltages;

FIG. 6 graphically illustrates a relationship between a peak transconductance of the SOI MESFET pass transistor and a source-to-drain voltage of the SOI MESFET pass transistor;

FIG. 7 graphically illustrates the PSR of the LDO regulator of FIG. 1 for two different substrate voltages;

FIG. 8 illustrates a LDO regulator including a SOI MESFET pass transistor wherein the LDO regulator is configured in an ultra-low dropout voltage mode by hard-wiring a substrate of the SOI MESFET pass transistor to the supply voltage during manufacturing according to one embodiment of the present disclosure;

FIG. 9 illustrates a LDO regulator including a SOI MESFET pass transistor wherein the LDO regulator is configured in a high PSR mode by hard- wiring a substrate of the SOI MESFET pass transistor to Ground during manufacturing according to one embodiment of the present disclosure; and

FIG. 10 illustrates a LDO regulator including a MESFET pass transistor and a switch for disconnecting the MESFET pass transistor from the supply voltage upon detection of one or more predefined conditions according to one embodiment of the present disclosure.

### DETAILED DESCRIPTION

The embodiments set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

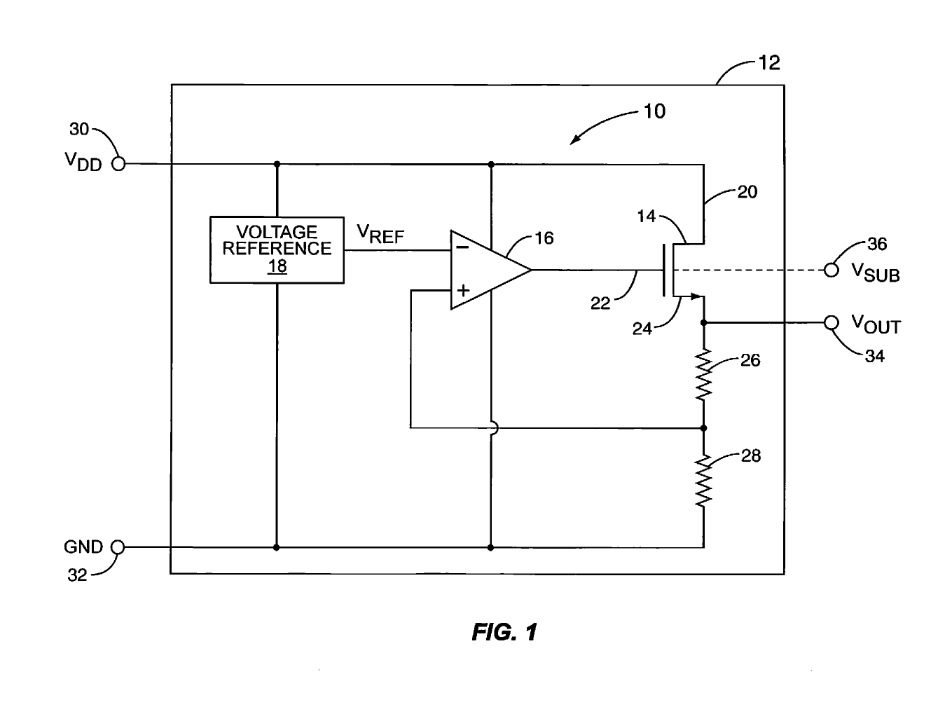

FIG. 1 illustrates a Low Dropout (LDO) regulator 10 implemented on an integrated circuit die 12 according to one embodiment of the present disclosure. The LDO regulator 10 includes an n-channel Silicon-on-Insulator (SOI) Metal Semiconductor Field Effect Transistor (MESFET) pass transistor 14 and error amplification circuitry, which in this embodiment is formed by an error amplifier 16 and a voltage reference 18 connected as shown. However, other implementations of the error amplification circuitry may alternatively be used. In this embodiment, the SOI MESFET pass transistor 14 is connected in a source-follower configuration. Specifically, the SOI MESFET pass transistor 14 includes a drain terminal 20, a gate terminal 22, and a source terminal 24. The drain terminal 20 of the SOI MESFET pass transistor 14 is connected to a supply voltage (V_{DD}) of the LDO regulator 10. The gate terminal 22 of the SOI MESFET pass transistor 14 is connected to an output of the error amplifier 16. The source terminal 24 of the SOI MESFET pass transistor 14 provides a regulated output voltage (Vₒᵤₜ) of the LDO regulator 10 and is connected to a non-inverting input (+) of the error amplifier 16 via a voltage divider, which is formed by resistors 26 and 28.

The regulated output voltage (Vₒᵤₜ) is controlled by a feedback loop formed by the voltage divider (i.e., the resistors 26 and 28) and the error amplifier 16 such that:

$${V}_{OUT} = ( 1 + \frac{R 1}{R 2} ) \cdot {V}_{REF} , \qquad ( 1 )$$

where R1 is a resistance of the resistor 26, R2 is a resistance of the resistor 28, and V_{REF} is a voltage output by the voltage reference 18. In operation, the error amplifier 16 modulates a gate voltage (V_{G}) at the gate terminal 22 of the SOI MESFET pass transistor 14 based on a difference between the reference voltage (V_{REF}) and the regulated output voltage (Vₒᵤₜ) such that the regulated output voltage (Vₒᵤₜ) remains at a desired output voltage during normal operation. More specifically, the error amplifier 16 modulates the gate voltage (V_{G}) at the gate terminal 22 of the SOI MESFET pass transistor 14 based on a difference between the reference voltage (V_{REF}) and a feedback voltage from the voltage divider that is indicative of the regulated output voltage (Vₒᵤₜ). As an example, the supply voltage (V_{DD}) may be 5 volts (V), and the LDO regulator 10 may provide a 3.3V regulated output voltage (Vₒᵤₜ).

In this embodiment, the integrated circuit die 12 has four input/output (I/O) pins. Namely, the integrated circuit die 12 has a supply voltage (V_{DD}) input pin 30 through which the supply voltage (V_{DD}) is provided to the LDO regulator 10 from an external source such as a battery and a ground (GND) pin 32 through which Ground is provided to the LDO regulator 10 from an external source such as the battery supplying the supply voltage (V_{DD}). In addition, the integrated circuit die 12 includes a regulated output voltage pin 34 through which the LDO regulator 10 provides the regulated output voltage (Vₒᵤₜ) to an external circuit or load. Lastly, the integrated circuit die 12 includes a substrate voltage (V_{SUB}) input pin 36 through which a substrate voltage (V_{SUB}) is applied to a substrate of the SOI MESFET pass transistor 14.

As discussed below, the substrate voltage (V_{suB}) input pin 36 is used to configure the LDO regulator 10 in an ultra-low dropout voltage mode or a high Power Supply Rejection (PSR) mode. Specifically, the LDO regulator 10 is configured in the ultra-low dropout voltage mode by applying a voltage that is greater than or substantially equal to a nominal value of the regulated output voltage (V_{ouT}) to the substrate of the SOI MESFET pass transistor 14 via the substrate voltage (V_{suB}) input pin 36. Similarly, the LDO regulator 10 is configured in the high PSR mode by applying a voltage that is less than the nominal value of the regulated output voltage (V_{ouT}) to the substrate of the SOI MESFET pass transistor 14 via the substrate voltage (V_{suB}) input pin 36. Preferably, the LDO regulator 10 is configured in the ultra-low dropout voltage mode by applying the supply voltage (V_{DD}) to the substrate voltage (V_{suB}) input pin 36 or the high PSR mode by applying ground (GND) to the substrate voltage (V_{suB}) input pin 36.

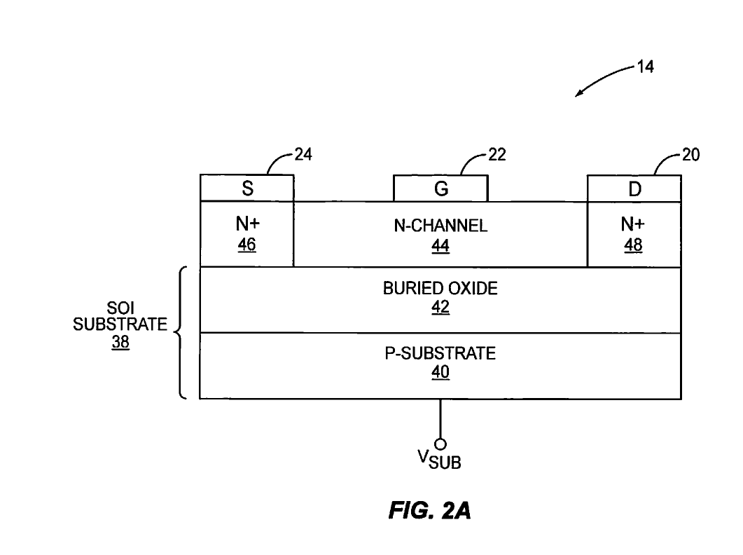

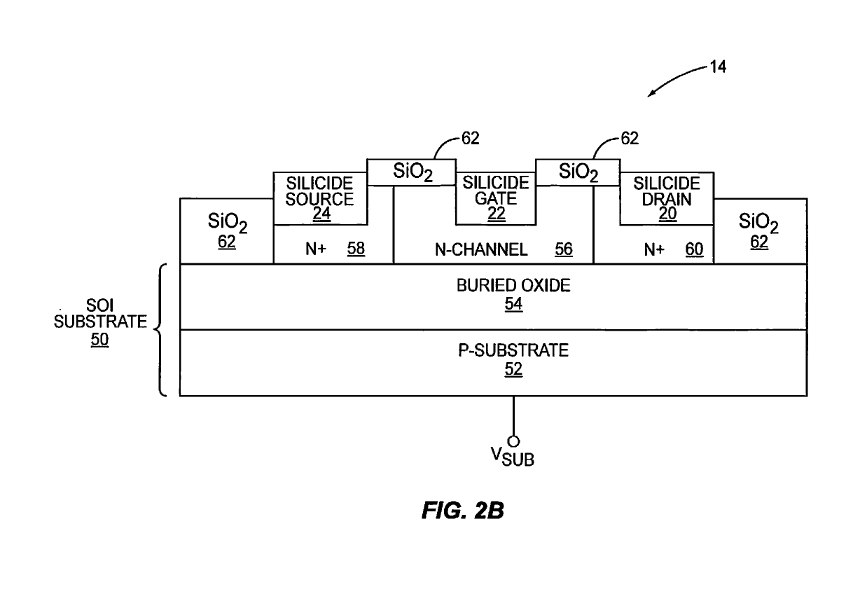

FIGS. 2A and 2B illustrate two exemplary embodiments of the SOI MESFET pass transistor 14 in which the substrate voltage (V_{suB}) is applied to the substrate of the SOI MESFET pass transistor 14. In essence, the substrate of the SOI MESFET pass transistor 14 operates as a fourth terminal or second gate of the SOI MESFET pass transistor 14. Specifically, as illustrated in FIG. 2A, the SOI MESFET pass transistor 14 includes an SOI substrate 38. The SOI substrate 38 includes a p-type Silicon substrate 40, a buried oxide layer 42, and an n-type channel 44 arranged as shown. In an exemplary embodiment, the buried oxide layer 42 is approximately 400 nanometers (nm) thick, and the n-type channel 44 is approximately 200 nm thick. Highly doped N+source and drain regions 46 and 48 are formed adjacent to the n-type channel 44 and above the buried oxide layer 42, as shown. Lastly, metal or metallic source, gate, and drain terminals 24, 22, and 20 are formed on the N+source region 46, the n-type channel 44, and the N+drain region 48, respectively. Importantly, the substrate voltage (V_{suB}) is applied to the p-type Silicon substrate 40 where the p-type Silicon substrate 40, which is a conducting substrate, operates as a fourth terminal of the SOI MESFET pass transistor 14. Note, however, that the application of the substrate voltage (V_{suB}) to the p-type Silicon substrate 40 is to be distinguished from body biasing, which is sometimes used for Complementary Metal Oxide Semiconductor (CMOS) transistors.

FIG. 2B illustrates an embodiment of the SOI MESFET pass transistor 14 that may be fabricated using a standard CMOS process according to one embodiment of the present disclosure. As such, the SOI MESFET pass transistor 14 is enabled to be integrated with CMOS devices on the integrated circuit die 12 (FIG. 1) using a standard unchanged CMOS fabrication process. For more details regarding the fabrication of MESFETs and CMOS devices using a standard CMOS process, the interested reader is directed to U.S. Pat. No. 7,589,007, entitled MESFETS INTEGRATED WITH MOSFETS ON COMMON SUBSTRATE AND METHODS OF FORMING THE SAME, which was issued on Sep. 15, 2009, and is hereby incorporated herein by reference in its entirety.

As illustrated, the SOI MESFET pass transistor 14 of FIG. 2B includes an SOI substrate 50. The SOI substrate 50 includes a p-type Silicon substrate 52, a buried oxide layer 54, and an n-type channel 56 arranged as shown. In an exemplary embodiment, the buried oxide layer is approximately 400 nm thick, and the n-type channel 56 is approximately 200 nm thick. Highly doped N+source and drain regions 58 and 60 are formed adjacent to the n-type channel 56 and above the buried oxide layer 54, as shown. Silicide source, gate, and drain terminals 24, 22, and 20 are formed on the N+source region 58, the n-type channel 56, and the N+drain region 60, respectively. Lastly, Silicon Dioxide regions 62 are included as insulating regions. It should be noted that Silicon Dioxide is exemplary. Other insulating materials such as, for example, Silicon Nitride may be used for the regions 62. Importantly, the substrate voltage (V_{suB}) is applied to the p-type Silicon substrate 52 where the p-type Silicon substrate 52, which is a conducting substrate, operates as a fourth terminal of the SOI MESFET pass transistor 14. Again, the application of the substrate voltage (V_{suB}) to the p-type Silicon substrate 52 is to be distinguished from body biasing, which is sometimes used for CMOS transistors.

One key specification of the LDO regulator 10 is dropout voltage. The dropout voltage of the LDO regulator 10 is a minimum voltage difference between the regulated output voltage (V_{ouT}) output by the LDO regulator 10 and the supply voltage (V_{DD}) required for the LDO regulator 10 to properly regulate the output voltage (V_{ouT}). Specifically, in this embodiment, the dropout voltage of the LDO regulator 10 is a voltage drop across the SOI MESFET pass transistor 14 at a point where the regulated output voltage (V_{ouT}) has dropped a defined amount below a nominal value for the regulated output voltage (V_{ouT}). For example, the dropout voltage may be a voltage drop across the SOI MESFET pass transistor 14 when the regulated output voltage (V_{ouT}) has dropped 2% below its nominal value. The smaller the dropout voltage, the lower the supply voltage (V_{DD}) can fall before the LDO regulator 10 ceases to function properly. If the supply voltage (V_{DD}) is provided by a battery, a lower dropout voltage translates directly to longer battery life.

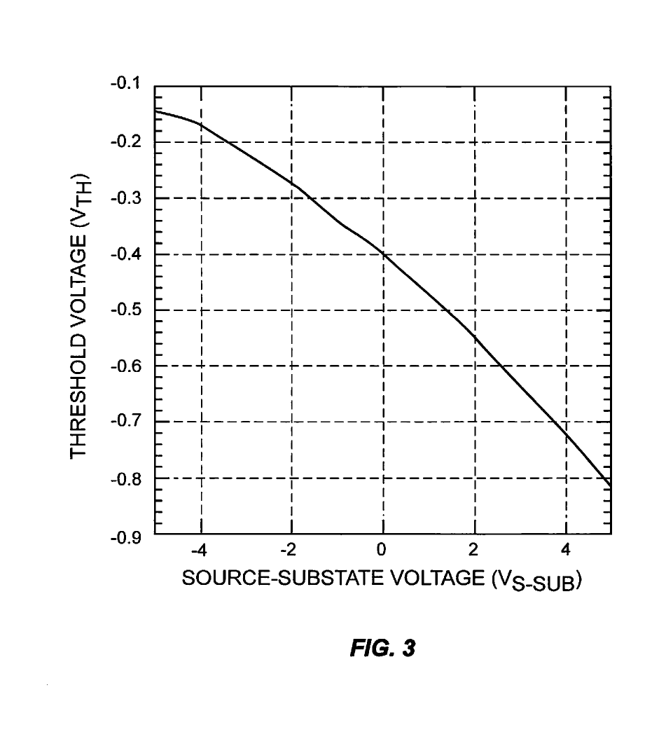

FIG. 3 graphically illustrates a relationship between a threshold voltage (Vₜₕ) of an exemplary embodiment of the SOI MESFET pass transistor 14 versus a source-to-substrate voltage (V_{ssuB}) of the SOI MESFET pass transistor 14. For this example, the SOI MESFET pass transistor 14 is a 100 micrometer wide, 0.6 micrometer SOI MESFET. The source-to-substrate voltage (V_{suB}) is a difference between the voltage at the source of the SOI MESFET pass transistor 14, which is the regulated output voltage (Vₒᵤₜ and the substrate voltage (V_{suB}). As illustrated, as the source-to-substrate voltage (V_{s-suB}) increases, the threshold voltage (Vₜₕ) also increases. Because the SOI MESFET pass transistor 14 is a depletion mode device, as the threshold voltage (Vₜₕ) increases (i.e., becomes more positive), the SOI MESFET pass transistor 14 becomes easier to turn off. As such, fewer electrons are conducting current in the n-type channel, and a resistance (R_{oN}) of the SOI MESFET pass transistor 14 increases. As the resistance (R_{oN}) of the SOI MESFET pass transistor 14 increases, the dropout voltage (i.e., load current multiplied by R_{oN}) of the LDO regulator 10 also increases for a given load current.

In contrast, as the source-to-substrate voltage (V_{s-suB}) decreases, the threshold voltage (Vₜₕ) also decreases. Because the SOI MESFET pass transistor 14 is a depletion mode device, as the threshold voltage (Vₜₕ) decreases (i.e., becomes more negative), the SOI MESFET pass transistor 14 becomes harder to turn off. As such, more electrons are conducting current in the n-type channel, and a resistance (R_{oN}) of the SOI MESFET pass transistor 14 decreases. As the resistance (R_{oN}) of the SOI MESFET pass transistor 14 decreases, the dropout voltage (i.e., load current multiplied by R_{oN}) of the LDO regulator 10 also decreases for a given load current.

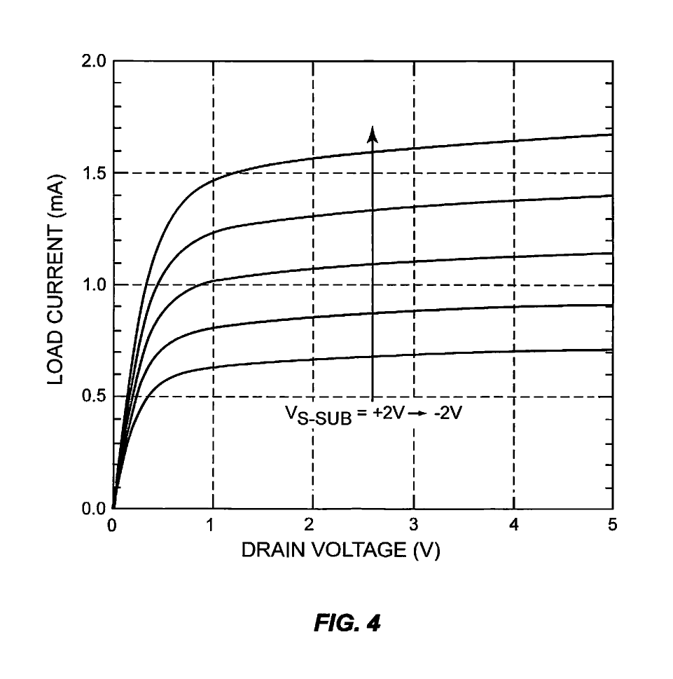

The fact that the resistance (R_{oN}) of the SOI MESFET pass transistor 14 and thus the dropout voltage of the LDO regulator 10 decreases as the source-to-substrate voltage (V_{s-suB}) decreases is also illustrated in FIG. 4.

FIG. 4 graphically illustrates a current through the SOI MESFET pass transistor 14 (i.e., the load current) as a function of a drain voltage of the SOI MESFET pass transistor 14 for an exemplary embodiment of the SOI MESFET pass transistor 14. For the LDO regulator 10 of FIG. 1, the drain voltage of the SOI MESFET pass transistor 14 is the supply voltage (V_{DD}). As illustrated, for a given value of the supply voltage (V_{DD}), the load current through the SOI MESFET pass transistor 14 increases as the source-to-substrate voltage (V_{s-suB}) decreases from 2V to -2V. This indicates that the resistance (R_{oN}) of the SOI MESFET pass transistor 14, and thus the dropout voltage of the LDO regulator 10, decreases for a given value of the supply voltage (V_{DD}) as the source-to-substrate voltage (V_{s-suB}) decreases.

In light of the discussion of FIGS. 3 and 4 above, the substrate voltage (V_{suB}) of the SOI MESFET pass transistor 14 can be used to reduce the source-to-substrate voltage (V_{s-suB}) of the SOI MESFET pass transistor 14 in order to provide the ultra-low dropout voltage mode of operation for the LDO regulator 10. Again, by reducing the source-to-substrate voltage (V_{s-suB}), the threshold voltage (Vₜₕ) and the resistance (R_{oN}) of the SOI MESFET pass transistor 14 are also decreased. As a result of the reduction in the resistance (RoN) of the SOI MESFET pass transistor 14, the dropout voltage of the LDO regulator 10 is also reduced for a given load current. More specifically, in order to configure the LDO regulator 10 in the ultra-low dropout voltage mode of operation, the substrate voltage (V_{suB}) is set to a voltage that is equal to or greater than the source voltage of the SOI MESFET pass transistor 14, which for the LDO regulator 10 is the regulated output voltage (V_{ouT}). In the preferred embodiment, the substrate voltage (V_{suB}) is set to the supply voltage (V_{DD}) for the ultra-low dropout voltage mode of operation. As a result, the source-to- substrate voltage (V_{s-suB}) is equal to or less than OV, which in turn results in a reduced dropout voltage for the LDO regulator 10.

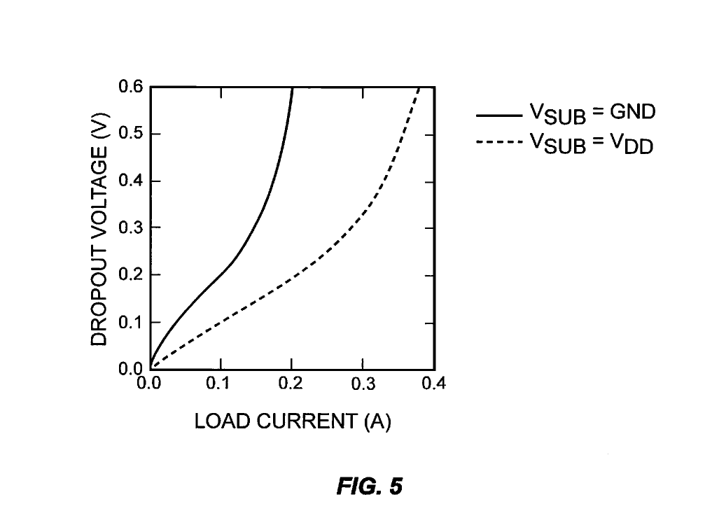

FIG. 5 graphically illustrates the reduction in the dropout voltage of the LDO regulator 10 in the ultra-low dropout voltage mode according to an exemplary embodiment. More specifically, FIG. 5 illustrates that, for a given load current, the dropout voltage of the LDO regulator 10 when the substrate voltage (V_{suB}) is set to the supply voltage (V_{DD}) is substantially less than the dropout voltage of the LDO regulator 10 when the substrate voltage (V_{suB}) is set to Ground (GND). Notably, for a load current of 0.1 Amps (A), the dropout voltage of the LDO regulator 10 is less than 0.1V when the substrate voltage (V_{suB}) is set to the supply voltage (V_{DD}) (i.e., when the LDO regulator 10 is in the ultra-low dropout voltage mode). This dropout voltage is two times less than that which would be seen for the same load current if the substrate voltage (V_{suB}) were set to Ground (GND).

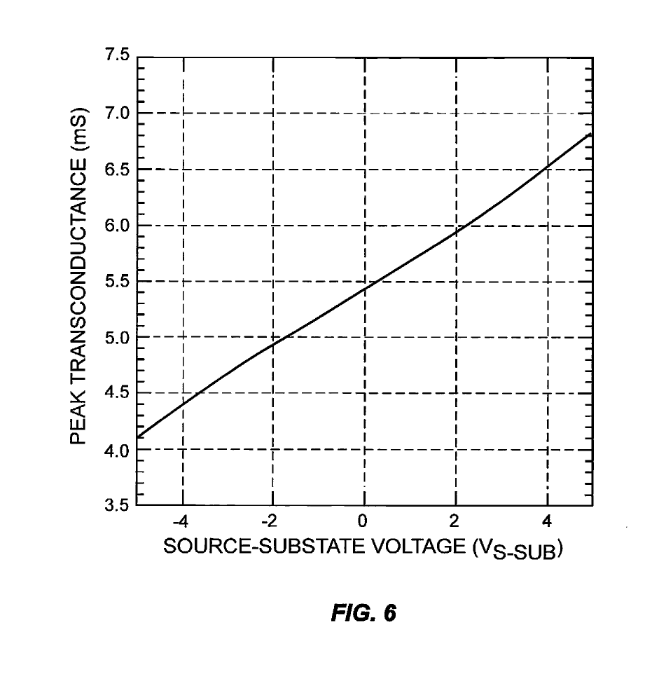

Another key specification of the LDO regulator 10 is PSR. The PSR of the LDO regulator 10 is inversely related to a peak transconductance (gₘ) of the SOI MESFET pass transistor 14. FIG. 6 graphically illustrates a relationship between the peak transconductance (gₘ) of an exemplary embodiment of the SOI MESFET pass transistor 14 and the source-to-substrate voltage (V_{s-suB}). Again, in this example, the SOI MESFET pass transistor 14 is a 100 micrometer wide, 0.6 micrometer SOI MESFET. As illustrated, as the source-to-substrate voltage (_{Vs-sus}) increases, the peak transconductance (gₘ) of the SOI MESFET pass transistor 14 decreases. As the peak transconductance (gₘ) of the SOI MESFET pass transistor 14 decreases, the PSR of the LDO regulator 10 increases. Conversely, as the source-to-substrate voltage (V_{s-suB}) decreases, the peak transconductance (gₘ) of the SOI MESFET pass transistor 14 increases. As the peak transconductance (gₘ) of the SOI MESFET pass transistor 14 increases, the PSR of the LDO regulator 10 decreases.

As such, the substrate voltage (V_{suB}) of the SOI MESFET pass transistor 14 can be used to increase the source-to-substrate voltage (V_{s-suB}) of the SOI MESFET pass transistor 14 in order to provide the high PSR mode of operation for the LDO regulator 10. Again, the PSR of the LDO regulator 10 is inversely related to the peak transconductance (gₘ) of the SOI MESFET pass transistor 14, and the PSR of the LDO regulator 10 can be increased by increasing the source-to-substrate voltage (V_{s-suB}) of the SOI MESFET pass transistor 14. Therefore, in order to configure the LDO regulator 10 in the high

PSR mode of operation, the substrate voltage (V_{suB}) is set to a voltage that is less than the source voltage of the SOI MESFET pass transistor 14, which for the LDO regulator 10 is the regulated output voltage (V_{ouT}). In the preferred embodiment, the substrate voltage (V_{suB}) is set to Ground (GND) for the high PSR mode of operation. As a result, the source-to-substrate voltage (V_{s-suB}) is greater than OV and is preferably equal to the source voltage, which in turn results in decreased peak transconductance (gₘ) for the SOI MESFET pass transistor 14 and increased PSR for the LDO regulator 10.

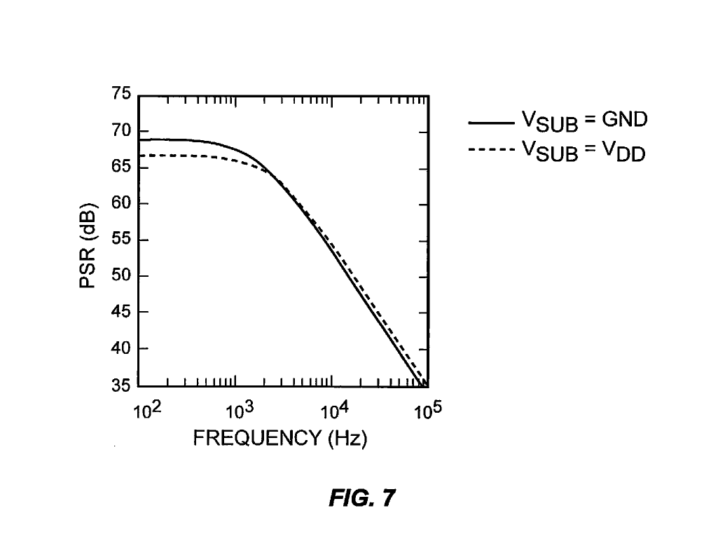

FIG. 7 graphically illustrates the improvement in the PSR of the LDO regulator 10 in the high PSR mode of operation according to an exemplary embodiment. More specifically, FIG. 7 illustrates that, particularly for lower frequencies, the PSR of the LDO regulator 10 when the substrate voltage (V_{suB}) is set to the Ground (GND) is substantially greater than the PSR of the LDO regulator 10 when the substrate voltage (V_{suB}) is set to the supply voltage (V_{DD}). For example, for frequencies in the range of 0-1000 Hertz (Hz), the PSR of the LDO regulator 10 is approximately 68 decibels (dB) if the substrate voltage (V_{suB}) is set to Ground (GND) as compared to approximately 66 dB if the substrate voltage (V_{suB}) is set to the supply voltage (V_{DD}).

Based on the discussion above, the LDO regulator 10 may be optimized for either ultra-low dropout operation or high PSR operation by setting the substrate voltage (V_{suB}) to the appropriate voltage. Preferably, the LDO regulator 10 is optimized for ultra-low dropout voltage operation by setting the substrate voltage (V_{suB}) to a voltage that is equal to or greater than the source voltage of the SOI MESFET pass transistor 14. Again, for ultra-low dropout voltage operation, the substrate voltage (V_{suB}) is preferably set to the supply voltage (V_{DD}). Conversely, the LDO regulator 10 is optimized for high PSR operation by setting the substrate voltage (V_{suB}) to a voltage that is less than the source voltage of the SOI MESFET pass transistor 14. Again, for high PSR operation, the substrate voltage (V_{suB}) is preferably set to Ground (GND).

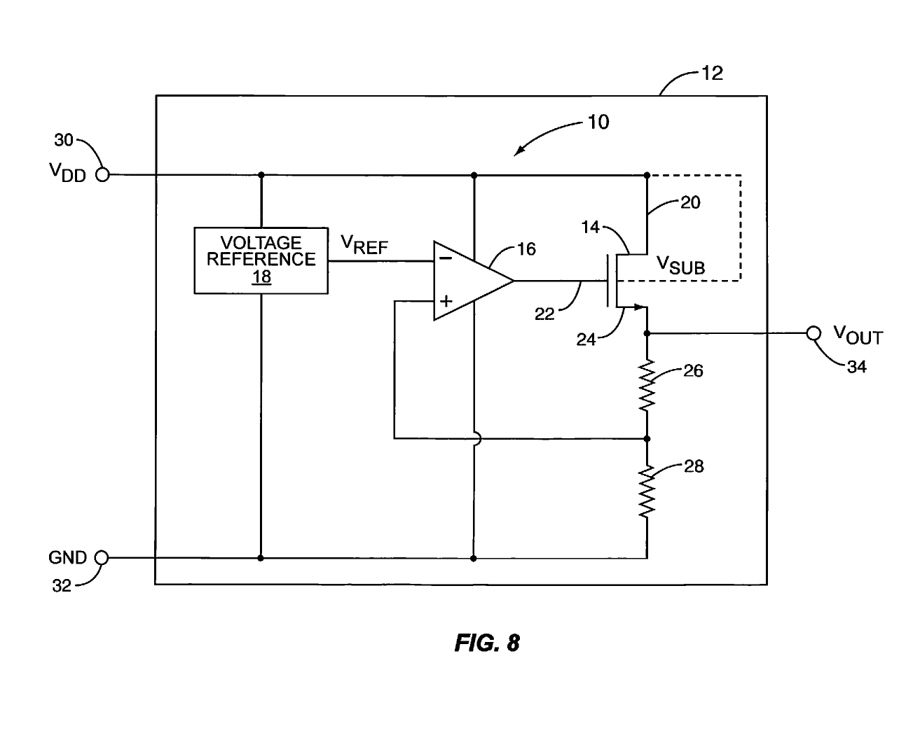

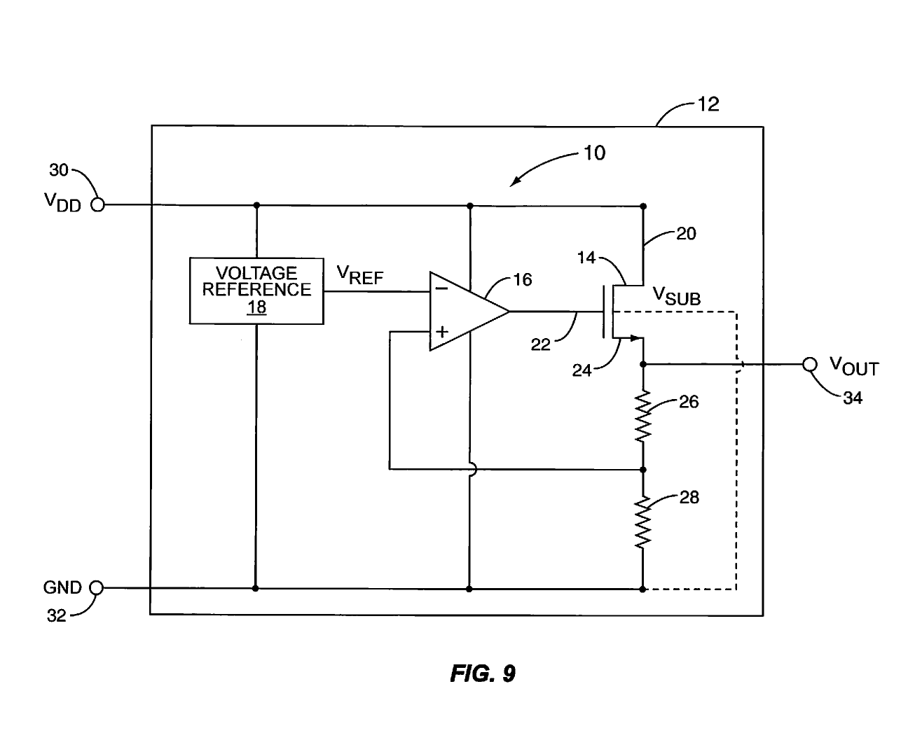

FIGS. 8 and 9 illustrate alternative embodiments of the LDO regulator 10 of FIG. 1 wherein, rather than being configurable, the substrate voltage (V_{suB}) is hard-wired during manufacturing. FIG. 8 illustrates an alternative embodiment wherein the LDO regulator 10 is implemented in the integrated circuit die 12 and configured in the ultra-low dropout voltage mode during manufacturing. Specifically, in this embodiment, rather than being re-configurable by the substrate voltage (V_{suB}) input pin 36 (FIG. 1), the substrate voltage (V_{suB}) is hard-wired to the supply voltage (V_{DD}), or more specifically the supply voltage (V_{DD}) input pin 30, during manufacturing. In this manner, the LDO regulator 10 is optimized for ultra-low dropout voltage operation during manufacturing. In contrast, FIG. 9 illustrates an alternative embodiment wherein the LDO regulator 10 is implemented in the integrated circuit die 12 and configured in the high PSR mode during manufacturing. Specifically, in this embodiment, rather than being re-configurable by the substrate voltage (V_{suB}) input pin 36 (FIG. 1), the substrate voltage (V_{suB}) is hard-wired to Ground (GND), or more specifically the Ground (GND) pin 32, during manufacturing. In this manner, the LDO regulator 10 is optimized for high PSR operation during manufacturing.

Another specification of the LDO regulator 10 is the amount of current used by the LDO regulator 10 when it is turned off, which is an important specification with respect to battery-life. One caveat to using the SOI MESFET pass transistor 14, which is a depletion mode device, is that the SOI MESFET pass transistor 14 always conducts current even when the gate-to-source voltage is zero and even when the SOI MESFET pass transistor 14 is turned off (i.e., the gate-to-source voltage is less than the negative threshold voltage). For example, for a MESFET having a gate width of 100 micrometers, gate and drain leakage currents of approximately 0.5 microamps continue to flow through the MESFET even when the MESFET is turned off. The SOI MESFET pass transistor 14 for the LDO regulator 10 typically has a much larger gate width (e.g., up to 10 millimeters or more), and the gate and drain leakage currents scale accordingly.

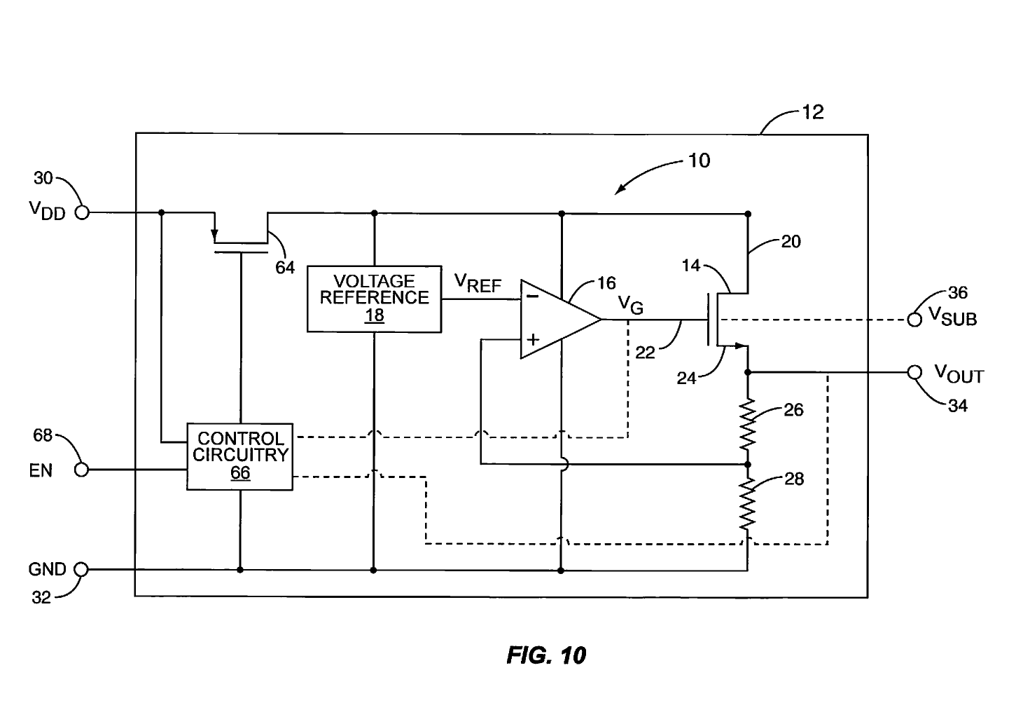

FIG. 10 illustrates an embodiment of the LDO regulator 10 that further includes a p-type Metal Oxide Semiconductor (PMOS) transistor switch 64 and associated control circuitry 66 connected as shown. The control circuitry 66 may be enabled or disabled externally via an enable pin 68. Preferably, in this embodiment, the PMOS transistor switch 64 and the SOI MESFET pass transistor 14 are integrated using a standard CMOS fabrication process. Note that the LDO regulator 10 of FIG. 10 is not limited to use of the SOI MESFET pass transistor 14. Any type of n-channel MESFET may be used. However, the SOI MESFET pass transistor 14 is preferable because the SOI MESFET pass transistor 14 enables the LDO regulator 10 of FIG. 10 to be configured in either the ultra-low dropout voltage mode or the high PSR mode in the manner described above. Further, while in this embodiment the substrate voltage (V_{suB}) is configurable, the substrate voltage (V_{suB}) may alternatively be hard-wired as described above with respect to FIGS. 8 and 9.

The PMOS transistor switch 64 is controlled by the control circuitry 66 to connect the supply voltage (V_{DD}) to the drain terminal 20 of the SOI MESFET pass transistor 14 during normal operation and to disconnect the supply voltage (V_{DD}) from the SOI MESFET pass transistor 14 when one or more predefined conditions are detected by the control circuitry 66. The PMOS transistor switch 64 enables current through the SOI MESFET pass transistor 14 to be cut-off when the LDO regulator 10 is desired to be switched off. Note that while the PMOS transistor switch 64 is used in this embodiment, other types of switches may alternatively be used.

The PMOS transistor switch 64 contributes to the dropout voltage of the LDO regulator 10. Specifically, the dropout voltage of the LDO regulator 10 including the PMOS transistor switch 64 can be defined as:

(2)

^{V}DO ^{V}DO,PMOS ^{±V}DO,MESFET where V_{DO}is the dropout voltage of the LDO regulator 10, V_{DO,PMOS} is the dropout voltage of the PMOS transistor switch 64, and V_{DO,MESFET} is the dropout voltage of the SOI MESFET pass transistor 14. Equation (2) can be rewritten as:

V_{DO}32 (R_{ON,PMOS}+R_{ON,MESFET})·I _{LOAD} , where _{RON,PMOS} is the resistance (i.e., the on-resistance) of the PMOS transistor switch 64, R_{ON,MESFET} is the resistance (i.e., the on-resistance) of the SOI MESFET pass transistor 14, and I_{LOAD} is the load current flowing through the PMOS transistor switch 64 and the SOI MESFET pass transistor 14.

In order to minimize the effects of the PMOS transistor switch 64 on the dropout voltage of the LDO regulator 10, it is desirable to minimize the resistance (R_{ON,PMOS}) of the PMOS transistor switch 64. In order to do so, the size of the PMOS transistor switch 64 is preferably designed to operate in the linear regime (i.e., below saturation), and the PMOS transistor switch 64 is preferably sized such that the drain-to-source voltage of the PMOS transistor switch 64 is in the range of 5-10 millivolts (mV) for the nominal load current to be supplied by the LDO regulator 10. In contrast, the SOI MESFET pass transistor 14 is preferably biased into saturation and is sized to give a low dropout voltage. While the dropout voltage is a tradeoff between load current and chip size, in one preferred embodiment, the dropout voltage is less than 25 mV or in the range of 15-25 mV at the nominal load current. Further, the PMOS transistor switch 64 is preferably designed such that a die area required for the PMOS transistor switch 64 is less than or approximately equal to 10% of a die area required for the SOI MESFET pass transistor 14.

In this embodiment, the control circuitry 66 monitors the gate voltage (V_{G}) of the SOI MESFET pass transistor 14, the regulated output voltage (V_{ouT}), or both. Note, however, that in an alternative embodiment, the control circuitry 66 may control a voltage or current at the gate 22 and/or the output 34. For example, the voltage or current at the gate 22 may be controlled to optimize the performance of the LDO regulator 10. Returning to this embodiment, based on the gate voltage (V_{G}) and/or the regulated output voltage (V_{ouT}), the control circuitry 66 controls the PMOS transistor switch 64 such that the PMOS transistor switch 64 is on during normal operation and turned off when the LDO regulator 10 is desired to be turned off. In this embodiment, the control circuitry 66 turns the PMOS transistor switch 64 on by providing a low voltage level, such as Ground (GND), to a gate terminal of the PMOS transistor switch 64. Similarly, the control circuitry 66 turns the PMOS transistor switch 64 off by providing a high voltage level, such as the supply voltage (V_{DD}), to the gate terminal of the PMOS transistor switch 64. When the PMOS transistor switch 64 is turned off, the only current used by the LDO regulator 10 is a quiescent current used in the control circuitry 66, which will typically be less than 1 microamp. The control circuitry 66 may be implemented as digital logic. For example, the control circuitry 66 may include one or more Schmidt triggers that compare the gate voltage (V_{G}) and/or the regulated output voltage (V_{ouT}) to one or more predefined threshold voltages. The output(s) of the one or more Schmidt triggers may then be used to drive the gate terminal of the PMOS transistor switch 64.

In operation, the control circuitry 66 monitors the gate voltage (V_{G}) and/or the regulated output voltage (V_{ouT}) and turns the PMOS transistor switch 64 off when one or more predefined conditions occur. The one or more predefined conditions may include, but are not limited to, a short-circuit condition, a low-battery condition, a no-load or power down condition, or any combination thereof. The control circuitry 66 may also be used to shut-down the LDO regulator 10 after some defined period of inactivity. A short-circuit condition may be detected when the regulated output voltage (V_{ouT}) falls below a predefined threshold such as, for example, 0.5V. Upon detecting the short-circuit condition, the control circuitry 66 turns the PMOS transistor switch 64 off such that the LDO regulator 10 is shut-down, thereby protecting the LDO regulator 10 from damage due to the short-circuit condition. In a similar manner, a low-battery condition may be detected when the regulated output voltage (V_{ouT}) falls below a predefined threshold such as, for example, 3V in the case where the nominal regulated output voltage is 3.3V.

A no-load or power-down condition may occur when the load is disconnected from the LDO regulator 10 or when circuitry powered by the regulated output voltage (V_{ouT}) provided by the LDO regulator 10 is powered down (i.e., turned off). The no-load or power-down condition may be detected when the gate voltage (V_{G}) is substantially less than the source voltage (i.e., the regulated output voltage (V_{ouT})). More specifically, if the load is disconnected or powered down, the load current suddenly and significantly decreases. Note that the current through the resistors 26 and 28 is low since the resistors 26 and 28 are preferably large. In response to the sudden decrease in load current, drain-to-source voltage of the SOI MESFET pass transistor 14 also suddenly decreases, thereby suddenly increasing the source voltage of the SOI MESFET pass transistor 14. The error amplifier 16 then drives the gate voltage (V_{G}) of the SOI MESFET pass transistor 14 low in order to turn the SOI MESFET pass transistor 14 off and reduce the source voltage to the desired regulated output voltage value. At this point, the gate voltage (V_{G}) is substantially less, or much less, than the source voltage, and the control circuitry 66 therefore detects the no-load or power-down condition. The gate voltage (V_{G}) is substantially less than the source voltage when the difference between the source voltage and the gate voltage (V_{G}) is greater that a predefined threshold. This threshold may vary based on the particular implementation. As an example, if the supply voltage

(V_{DD}) is 5V, the threshold difference between the source and gate voltages may be 4V. In response, the control circuitry 66 turns the PMOS transistor switch 64 off.

Lastly, the SOI MESFET pass transistor 14 of the LDO regulator 10 (FIGS. 1 and 10) offers additional benefits. Specifically, because the SOI

MESFET pass transistor 14 is an n-channel device, there is no need for an external capacitor to stabilize the LDO regulator 10 as is needed for a traditional p-channel pass transistor (e.g., a PMOS pass transistor). In addition, traditional n-channel pass transistors (e.g., an NMOS pass transistor) are enhancement mode devices that, therefore, require charge pumps to directly drive the gates of the n-channel pass transistors. However, the SOI MESFET pass transistor 14 does not need a charge pump to directly drive the gate terminal 22 because the SOI MESFET pass transistor 14 is a depletion mode device.

Those skilled in the art will recognize improvements and modifications to the preferred embodiments of the present invention. All such improvements and modifications are considered within the scope of the concepts disclosed herein and the claims that follow.

What is claimed is:

1. A Low Dropout (LDO) regulator implemented in an integrated circuit die, comprising:
an n-channel Silicon-on-Insulator (SOI) Metal Semiconductor Field Effect Transistor (MESFET) pass transistor comprising a drain terminal coupled to a supply voltage input pin of the integrated circuit die and a source terminal coupled to a regulated output voltage pin of the integrated circuit die; and
error amplification circuitry adapted to modulate a gate terminal of the SOI MESFET pass transistor based on a reference voltage and a feedback voltage indicative of a voltage at the source terminal of the SOI MESFET pass transistor such that the voltage at the source terminal of the SOI MESFET pass transistor is provided as a regulated output voltage of the LDO regulator;
wherein the LDO regulator is configurable in either a ultra-low dropout voltage mode or a high Power Supply Rejection (PSR) mode by providing a voltage greater than or equal to the regulated output voltage to a substrate of the SOI MESFET pass transistor for the ultra-low dropout voltage mode and providing a voltage less than the regulated output voltage to the substrate of the SOI MESFET pass transistor for the high PSR mode.

2. The LDO regulator of claim 1 wherein the substrate of the SOI MESFET pass transistor is coupled to a substrate voltage input pin of the integrated circuit, and the LDO regulator is configured in the ultra-low dropout voltage mode by providing the voltage greater than or equal to the regulated output voltage to the substrate of the SOI MESFET pass transistor via the substrate voltage input pin and configured in the high PSR mode by providing the voltage less than the regulated output voltage to the substrate of the SOI MESFET pass transistor via the substrate voltage input pin.

3. The LDO regulator of claim 1 wherein the voltage greater than or equal to the regulated output voltage is at least approximately equal to a supply voltage of the LDO regulator.

4. The LDO regulator of claim 1 wherein the voltage less than the regulated output voltage is at least approximately equal to Ground.

5. The LDO regulator of claim 1 wherein a dropout voltage of the LDO regulator when configured in the ultra-low dropout voltage mode is less than or equal to 25 millivolts (mV) at a nominal load current of the LDO regulator.

6. The LDO regulator of claim 1 wherein a PSR of the LDO regulator when configured in the high PSR mode is greater than a PSR of the LDO regulator when configured in the ultra-low dropout voltage mode.

7. The LDO regulator of claim 1 further comprising switching circuitry coupled in series between the supply voltage input pin of the integrated circuit die and the drain terminal of the SOI MESFET pass transistor.

8. The LDO regulator of claim 1 further comprising a p-channel Metal Oxide Semiconductor (PMOS) transistor switch coupled in series between the supply voltage input pin of the integrated circuit die and the drain terminal of the SOI MESFET pass transistor.

9. The LDO regulator of claim 8 wherein the PMOS transistor switch and the SOI MESFET pass transistor are integrated via a standard Complementary Metal Oxide Semiconductor (CMOS) fabrication process.

10. The LDO regulator of claim 8 wherein a dropout voltage of the PMOS transistor switch is substantially less than a dropout voltage of the SOI MESFET pass transistor such that the PMOS transistor switch does not substantially affect a dropout voltage of the LDO regulator.

11. The LDO regulator of claim 10 wherein the dropout voltage of the PMOS transistor switch is less than or equal to ten (10) millivolts (mV), and the dropout voltage of the SOI MESFET pass transistor is less than or equal to twenty-five (25) mV.

12. The LDO regulator of claim 10 wherein the dropout voltage of the PMOS transistor switch is in a range of and including five (5) to ten (10) millivolts (mV), and the dropout voltage of the SOI MESFET pass transistor is in a range of and including fifteen (15) to twenty-five (25) mV.

13. The LDO regulator of claim 8 wherein a die area of the PMOS transistor switch is less than or equal to ten percent of a die area of the SOI MESFET pass transistor.

14. The LDO regulator of claim 8 further comprising control circuitry adapted to:
detect an occurrence of a predefined condition; and
turn off the PMOS transistor switch upon detecting the occurrence of the predefined condition.

15. The LDO regulator of claim 14 wherein the predefined condition is one of at least one condition being monitored for by the control circuitry, and the at least one condition comprises one or more of a group consisting of: a short-circuit condition, a low-battery condition, a no-load condition, and a power down condition.

16. The LDO regulator of claim 14 wherein the control circuitry is further adapted to: monitor a gate voltage of the SOI MESFET pass transistor; and
detect the occurrence of the predefined condition based on the gate voltage of the SOI MESFET pass transistor.

17. The LDO regulator of claim 14 wherein the control circuitry is further adapted to:
monitor the regulated output voltage of the LDO regulator; and
detect the occurrence of the predefined condition based on the regulated output voltage of the LDO regulator.

18. The LDO regulator of claim 14 wherein the control circuitry is further adapted to:
monitor the regulated output voltage of the LDO regulator and a gate voltage of the SOI MESFET pass transistor; and
detect the occurrence of the predefined condition based on the regulated output voltage of the LDO regulator and the gate voltage of the SOI MESFET pass transistor.

19. A Low Dropout (LDO) regulator implemented in an integrated circuit die, comprising:
an n-channel Metal Semiconductor Field Effect Transistor (MESFET) pass transistor comprising a source terminal coupled to a regulated output voltage pin of the integrated circuit die;
a p-channel Metal Oxide Semiconductor (PMOS) transistor switch coupled in series between a drain terminal of the MESFET pass transistor and a supply voltage input pin of the integrated circuit die;
error amplification circuitry adapted to modulate a gate terminal of the MESFET pass transistor based on a reference voltage and a feedback voltage indicative of a voltage at the source terminal of the MESFET pass transistor such that the voltage at the source terminal of the MESFET pass transistor is a regulated output voltage of the LDO regulator; and control circuitry having an output coupled to a gate terminal of the PMOS transistor switch and adapted to:
detect an occurrence of a predefined condition; and
turn off the PMOS transistor switch upon detecting the occurrence of the predefined condition.

20. The LDO regulator of claim 19 wherein the PMOS transistor switch and the MESFET pass transistor are integrated via a standard Complementary Metal Oxide Semiconductor (CMOS) fabrication process.

21. The LDO regulator of claim 19 wherein a dropout voltage of the PMOS transistor switch is substantially less than a dropout voltage of the MESFET pass transistor such that the PMOS transistor switch does not substantially affect a dropout voltage of the LDO regulator.

22. The LDO regulator of claim 21 wherein the dropout voltage of the PMOS transistor switch is less than or equal to ten (10) millivolts (mV), and the dropout voltage of the MESFET pass transistor is less than or equal to twenty-five (25) mV.

23. The LDO regulator of claim 21 wherein the dropout voltage of the PMOS transistor switch is in a range of and including five (5) to ten (10) millivolts (mV), and the dropout voltage of the MESFET pass transistor is in a range of and including fifteen (15) to twenty-five (25) mV.

24. The LDO regulator of claim 19 wherein a die area of the PMOS transistor switch is less than or equal to ten percent of a die area of the MESFET pass transistor.

25. The LDO regulator of claim 19 wherein the predefined condition is one of at least one condition being monitored for by the control circuitry, and the at least one condition comprises one or more of a group consisting of: a short-circuit condition, a low-battery condition, a no-load condition, and a power down condition.

26. The LDO regulator of claim 19 wherein the control circuitry is further adapted to:
monitor a gate voltage of the MESFET pass transistor; and
detect the occurrence of the predefined condition based on the gate voltage of the MESFET pass transistor.

27. The LDO regulator of claim 19 wherein the control circuitry is further adapted to:
monitor the regulated output voltage of the LDO regulator; and
detect the occurrence of the predefined condition based on the regulated output voltage of the LDO regulator.

28. The LDO regulator of claim 19 wherein the control circuitry is further adapted to:
monitor the regulated output voltage of the LDO regulator and a gate voltage of the MESFET pass transistor; and
detect the occurrence of the predefined condition based on the regulated output voltage of the LDO regulator and the gate voltage of the MESFET pass transistor.
